(19) United States
(12) Patent Application Publication
(10) Pub. No.: US 2011/0181190 A1
(43) Pub. Date: Jul. 28, 2011

(54) BRIGHTNESS ADJUSTING CIRCUIT FOR AN LED LAMP

(76) Inventor: Chiu-Min LIN, Guishan Township (TW)

(21) Appl. No.: 12/691,954

(22) Filed: Jan. 22, 2010

(51) Int. Cl. H05B 37/02

(52) U.S. Cl. 315/127; 315/307; 315/185 R

(57) ABSTRACT

A brightness adjusting circuit for an LED lamp has a compensating circuit, a bridge rectifier, a filter capacitor and a current limiting circuit. The compensating circuit is connected between an output terminal of a light regulator and an AC wire to output a regulated input voltage. The bridge rectifier is connected to the compensating circuit and converts the regulated input voltage to a DC voltage. The filter capacitor is connected to the bridge rectifier. The current limiting resistor is connected between the bridge rectifier and the LED lamp to limit a current flowing through the LED lamp. When the light regulator is adjusted, the regulated input voltage across is changed accordingly. Therefore, the DC voltage produced by the bridge rectifier is varied to regulate the brightness of the LED lamp.

### BACKGROUND OF THE INVENTION

1. Field of the Invention

The present invention relates to a brightness adjusting circuit for a Light-emitting diode (LED) lamp, especially to a brightness adjusting circuit that allows a light regulator to control the brightness of the LED lamp.

2. Description of the Related Art

Light adjustable lamps are often used to provide comfortable ambiance. With reference to FIG. 2, a conventional light adjustable lamp mainly includes an incandescent lamp (101) and a light regulator (102) connected in series. The light regulator (102) is composed of silicon-controlled elements such as DIAC (diode for alternating current) and TRIAC (triode for alternating current). By changing a trigging voltage applied to the silicon-controlled element, the conduction angle of the silicon-controlled element is adjusted to control the AC voltage across the incandescent lamp (101) and accordingly regulate the brightness of the incandescent lamp (101) to a desired level.

More and more LED-based lamps are used as lighting equipment and are replacing conventional incandescent lamps for saving energy and reducing power consumption. The LED-based lamps are driven by low DC voltages. However, the light regulator (102) is unable to directly regulate the DC voltage and cannot adjust the brightness of the LED-based lamps. Therefore, users have to use particular regulators to substitute the existed light regulators and almost abandon all original related control circuits.

To overcome the shortcomings, the present invention provides a brightness adjusting circuit for an LED lamp to mitigate or obviate the aforementioned problems.

### SUMMARY OF THE INVENTION

The main objective of the invention is to provide a brightness adjusting circuit for an LED lamp, wherein the brightness adjusting circuit allows an original light regulator to control the brightness of the LED lamp.

To achieve the objective, the brightness adjusting circuit for an LED lamp has a compensating circuit, a bridge rectifier, a filter capacitor and a current limiting circuit. The compensating circuit is connected between an output terminal of a light regulator and an AC wire to output a regulated input voltage. The bridge rectifier is connected to the compensating circuit and converts the regulated input voltage to a DC voltage. The filter capacitor is connected to the bridge rectifier. The current limiting resistor is connected between the bridge rectifier and the LED lamp to limit a current flowing through the LED lamp. When the light regulator is adjusted, the regulated input voltage across the compensating circuit is changed accordingly. Therefore, the DC voltage produced by the bridge rectifier is varied to regulate the brightness of the LED lamp.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a brightness adjusting circuit for an LED lamp in accordance with the present invention; and

FIG. 2 is a block circuit diagram of a conventional light adjustable lamp.

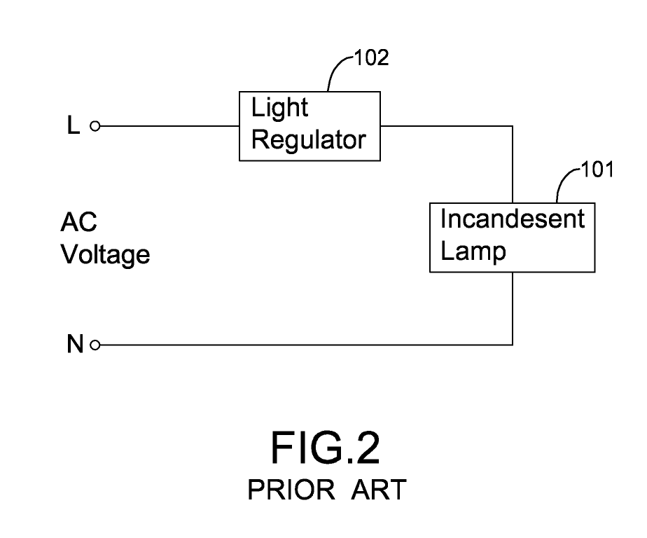

### DETAILED DESCRIPTION OF THE PREFERRED EMBODIMENTS

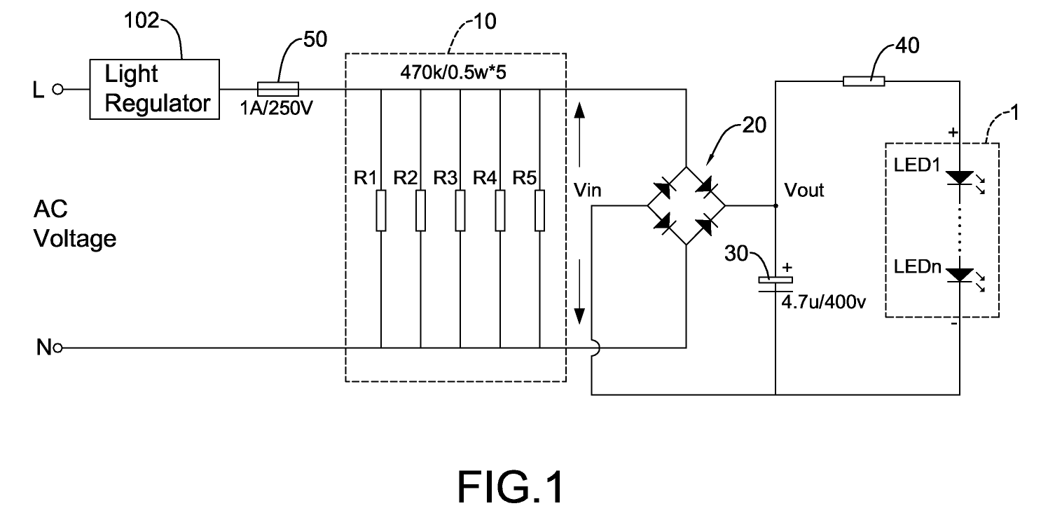

With reference to FIG. 1, a brightness adjusting circuit for an LED lamp (1) in accordance with the present invention is operated with a light regulator (102) and comprises a compensating circuit (10), a bridge rectifier (20), a filter capacitor (30) and a current limiting resistor (40) and may further have a fuse (50).

The light regulator (102) is connected to a first AC wire (L) and has an output terminal. The light regulator (102) comprises silicon-controlled elements such as a DIAC (diode for alternating current) and a TRIAC (triode for alternating current). The LED lamp (1) has a positive terminal and a negative terminal and comprises multiple LEDs connected in series.

The compensating circuit (10) is connected between the output terminal of the light regulator (102) and a second AC wire (N), and comprises multiple resistors (R1)˜(R5) connected in parallel. Preferably, all resistors (R1)˜(R5) have the same resistance value. A regulated input voltage (Vin) is established across the compensating circuit (10).

The bridge rectifier (20) has a first input terminal, a second input terminal, a positive output terminal and a negative output terminal. The first and second input terminals are respectively connected to the output terminal of the light regulator (102) and the second AC wire (N) to receive the regulated input voltage (Vin). The bridge rectifier (20) converts the regulated input voltage (Vin) to a DC voltage (Vout) output from the positive and negative output terminals.

The filter capacitor (30) is connected between the positive and negative output terminals of the bridge rectifier (20).

The current limiting resistor (40) is connected between the positive output terminal of the bridge rectifier (20) and the positive terminal of the LED lamp (1) to limit a current flowing through the LED lamp (1).

The fuse (50) is connected between the output terminal of the light regulator (102) and the positive output terminal of the bridge rectifier (20) to provide an over-current protection.

When the light regulator (102) is adjusted, a regulated input voltage (Vin) across the resistors (R1)˜(R5) is changed accordingly. Therefore, the DC voltage (Vout) produced by the bridge rectifier (20) is varied to regulate the brightness of the LED lamp (1) because a current flowing through the LED lamp (1) is proportional to the DC voltage (Vout).

In short, the brightness adjusting circuit can be integrated with the original light regulator (102) so that the light regulator (102) is able to control the LED lamp (1).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brightness adjusting circuit for an LED lamp, the brightness adjusting circuit comprising:
a compensating circuit adapted to connect to an output terminal of a light regulator and connected to an AC wire of an AC voltage to output a regulated input voltage;
a bridge rectifier having a first input terminal, a second input terminal, a positive output terminal and a negative output terminal, the first and second input terminals respectively connected to the output terminal of the light regulator and the AC wire to convert the regulated input voltage to a DC voltage;
a filter capacitor connected between the positive and negative output terminals of the bridge rectifier;
a current limiting resistor connected to the positive output terminal of the bridge rectifier and adapted to connect to the LED lamp.

2. The brightness adjusting circuit as claimed in claim 1, wherein the compensating circuit comprises multiple resistors connected in parallel.

3. The brightness adjusting circuit as claimed in claim 1, wherein the multiple resistors of the compensating circuit have the same resistance value.

4. The brightness adjusting circuit as claimed in claim 2, wherein the LED lamp comprises multiple LEDs connected in series.

5. The brightness adjusting circuit as claimed in claim 4, wherein a fuse is further connected between the output terminal of the light regulator and the first input terminal of the bridge rectifier.

6. The brightness adjusting circuit as claimed in claim 3, the compensating circuit comprises five resistors connected in parallel.
